(19) United States
(12) Patent Application Publication
(10) Pub. No.: US 2016/0109926 A1
(43) Pub. Date: Apr. 21, 2016

(54) MODIFIED WRITE PROCESS BASED ON A POWER CHARACTERISTIC FOR A DATA STORAGE DEVICE

(71) Applicant: SANDISK TECHNOLOGIES INC., Plano, TX (US)

(72) Inventors: STELLA ACHTENBERG, NETANYA (IL); IDAN ALROD, HERZLIYA (IL); ERAN SHARON, RISHON LEZION (IL); ARIEL NAVON, REVAVA (IL); ALEXANDER BAZARSKY, HOLON (IL); TZ-YI LIU, PALO ALTO, CA (US); TIANHONG YAN, SARATOGA, CA (US)

(73) Assignee: SANDISK TECHNOLOGIES INC.

(21) Appl. No.: 14/518,902

(22) Filed: Oct. 20, 2014

(51) Int. Cl. G06F 1/32; G06F 12/02

(52) U.S. Cl. CPC G06F 1/3234; G06F 12/023; G06F 2212/251

(57) ABSTRACT

A data storage device includes a memory die. The memory die includes a resistive memory. A method includes determining a power characteristic associated with performing a write process to write data to the resistive memory. The method further includes initiating a modified write process in response to detecting that the power characteristic satisfies a threshold.

### FIELD OF THE DISCLOSURE

The present disclosure is generally related to data storage devices and more particularly to write processes at data storage devices.

### BACKGROUND

Non-volatile data storage devices have enabled increased portability of data and software applications. For example, multi-level cell (MLC) storage elements of a memory device may each store multiple bits of data, enhancing data storage density as compared to single-level cell (SLC) memory devices. Consequently, memory devices may enable users to store and access a large amount of data.

Storing and accessing a large amount of data at a memory device consumes power. To reduce power consumption, some memory devices use fewer device components, such as by reducing a number of transistors of the memory device in order to reduce current consumption. In some cases, reducing the number of transistors or other devices may reduce device performance (e.g., by reducing processing capability and/or data storage capacity of the memory device).

### SUMMARY

A data storage device includes a memory die. The memory die may include a resistive memory, such as a resistive random access memory (ReRAM) having a three-dimensional (3D) memory configuration. The memory die may perform a write process at the resistive memory using multiple operations, such as parallel operations. In some cases, the execution of parallel operations may be associated with high peak power consumption (e.g., power consumption at or above a peak power threshold). For example, concurrent programming of multiple low-resistance states at the resistive memory may consume more power as compared to concurrent programming of multiple high-resistance states. High peak power consumption may physically stress certain device components, which can result in poor performance or physical damage to the data storage device.

To reduce peak power consumption, the data storage device may determine a power characteristic associated with a write process to write data to the resistive memory (e.g., whether writing the data is likely to result in high peak power consumption). If the power characteristic indicates that high peak power consumption is probable, the data storage device may initiate a modified write process. As a non-limiting, illustrative example, the data storage device may rearrange a writing schedule of write operations to reduce a number of low-resistance states programmed concurrently at the resistive memory. Other illustrative examples of write process modifications are described below.

### BRIEF DESCRIPTION OF THE DRAWINGS

FIG. 1 is a block diagram of a particular illustrative embodiment of a system that includes a data storage device configured to selectively modify write processes to reduce peak power consumption;

FIG. 2 is a diagram illustrating certain example structures and operations that may be associated with the data storage device of FIG. 1;

FIG. 3 is a diagram of a portion of an illustrative embodiment of a memory die that may be included in the data storage device of FIG. 1; and

FIG. 4 is a flow diagram of an illustrative method of operation of the data storage device of FIG. 1.

### DETAILED DESCRIPTION

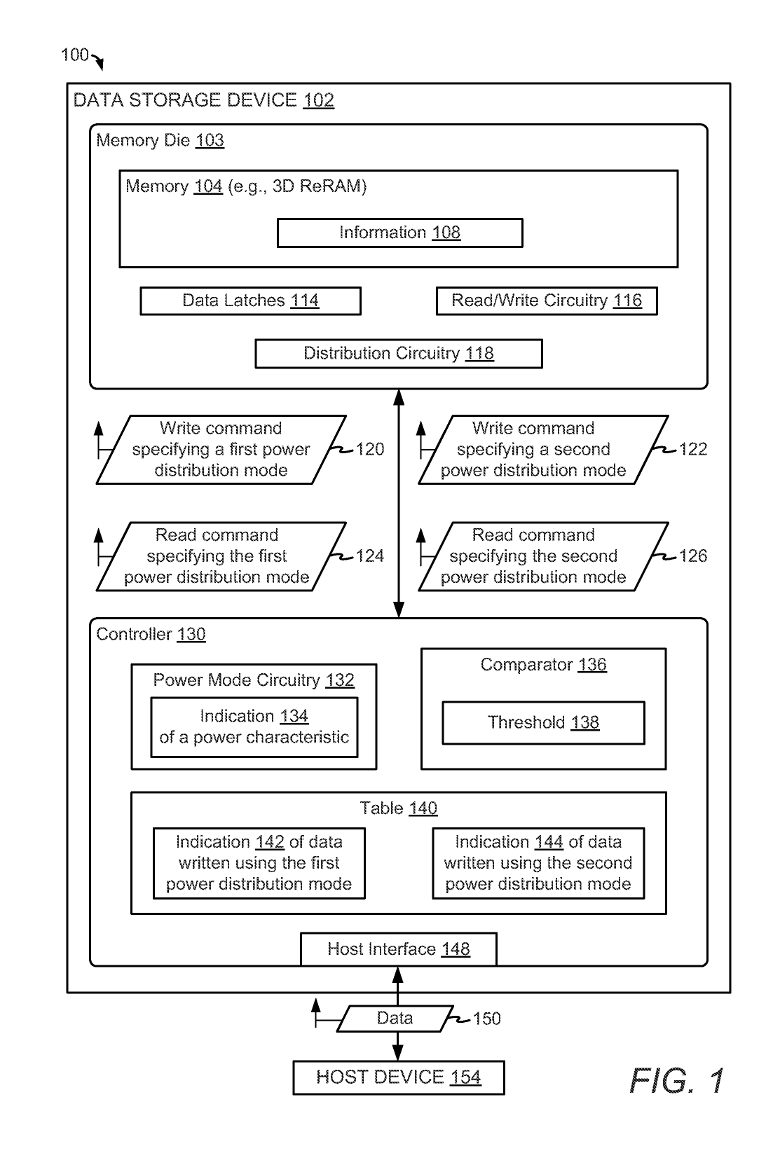

Referring to FIG. 1, an illustrative example of a system is depicted and generally designated 100. The system 100 includes a data storage device 102 and a host device 154. The data storage device 102 and the host device 154 may be operationally coupled via a connection, such as a bus or a wireless connection. The data storage device 102 may be embedded within the host device 154, such as in accordance with a Joint Electron Devices Engineering Council (JEDEC) Solid State Technology Association Universal Flash Storage (UFS) configuration. Alternatively, the data storage device 102 may be removable from the host device 154 (i.e., “removably” coupled to the host device 154). As an example, the data storage device 102 may be removably coupled to the host device 154 in accordance with a removable universal serial bus (USB) configuration.

The data storage device 102 includes a memory die 103 and a controller 130. The memory die 103 and the controller 130 may be coupled via one or more buses, one or more interfaces, and/or another structure. An interface may be wired (e.g., a bus structure) or wireless (e.g., a wireless communication interface). Although FIG. 1 depicts a single memory die (the memory die 103) for convenience, it should be appreciated that the data storage device 102 may include another number of memory dies corresponding to the memory die 103.

The memory die 103 includes a memory 104, such as a non-volatile memory. For example, the memory 104 may include a resistive memory, such as a resistive random access memory (ReRAM), as an illustrative example. The memory 104 may have a three-dimensional (3D) memory configuration, such as a vertical bit line (VBL) 3D architecture. For example, the memory 104 may include a 3D VBL ReRAM. In a particular implementation, the memory 104 is a non-volatile memory having a 3D memory configuration that is monolithically formed in one or more physical levels of arrays of memory cells having an active area disposed above a silicon substrate. Alternatively, the memory 104 may have another configuration, such as a two-dimensional (2D) memory configuration or a stacked 2D memory configuration.

The memory 104 may include storage elements (e.g., memory cells) and a plurality of bit lines and word lines connecting the storage elements. The storage elements of the memory 104 may each be programmed to a resistive state (e.g., a high-resistance state or a low-resistance state). The memory 104 may further include data latches 114, read/write circuitry 116, and distribution circuitry 118.

The controller 130 may include power mode circuitry 132 and a comparator 136. The controller 130 may be configured to store a table 140. The controller 130 may further include a host interface 148.

The controller 130 is configured to receive data and instructions from the host device 154 and to send data to the host device 154. For example, the controller 130 may receive data from the host device 154 via the host interface 148 and may send data to the host device 154 via the host interface 148.

The controller 130 is configured to send data and commands to the memory 104 and to receive data from the memory 104. For example, the controller 130 is configured to send data and a write command to cause the memory 104 to store the data to a specified address of the memory 104. The write command may specify a physical address of a portion of the memory 104 that is to store the data. The controller 130 is configured to send a read command to the memory 104 to access data from a specified address of the memory 104. The read command may specify the physical address of a portion of the memory 104.

The controller 130 may include an error correcting code (ECC) engine. The ECC engine may be configured to receive data and to generate one or more ECC codewords based on the data. The ECC engine may include a Hamming encoder, a Reed-Solomon (RS) encoder, a Bose-Chaudhuri-Hocquenghem (BCH) encoder, a low-density parity check (LDPC) encoder, a turbo encoder, an encoder configured to encode data according to one or more other ECC schemes, or a combination thereof. The ECC engine may be configured to decode data accessed from the memory 104. For example, the ECC engine may be configured to decode data accessed from the memory 104 to detect and correct one or more errors that may be present in the data, up to an error correcting capacity of the particular ECC scheme. The ECC engine may include a Hamming decoder, an RS decoder, a BCH decoder, an LDPC decoder, a turbo decoder, a decoder configured to decode data according to one or more other ECC schemes, or a combination thereof.

In a particular embodiment, the data storage device 102 includes a scrambler configured to “scramble” values of data to be written to the memory 104. The scrambler may be included in the controller 130 or the memory die 103, as illustrative examples. In this case, modification of a write process may be performed after data scrambling by the scrambler.

The host device 154 may correspond to a mobile telephone, a computer (e.g., a laptop, a tablet, or a notebook computer), a music player, a video player, a gaming device or console, an electronic book reader, a personal digital assistant (PDA), a portable navigation device, another electronic device, or a combination thereof. The host device 154 may communicate via a host controller, which may enable the host device 154 to communicate with the data storage device 102. The host device 154 may operate in compliance with a JEDEC Solid State Technology Association industry specification, such as an embedded MultiMedia Card (eMMC) specification or a Universal Flash Storage (UFS) Host Controller Interface specification. The host device 154 may operate in compliance with one or more other specifications, such as a Secure Digital (SD) Host Controller specification as an illustrative example. Alternatively, the host device 154 may communicate with the data storage device 102 in accordance with another communication protocol.

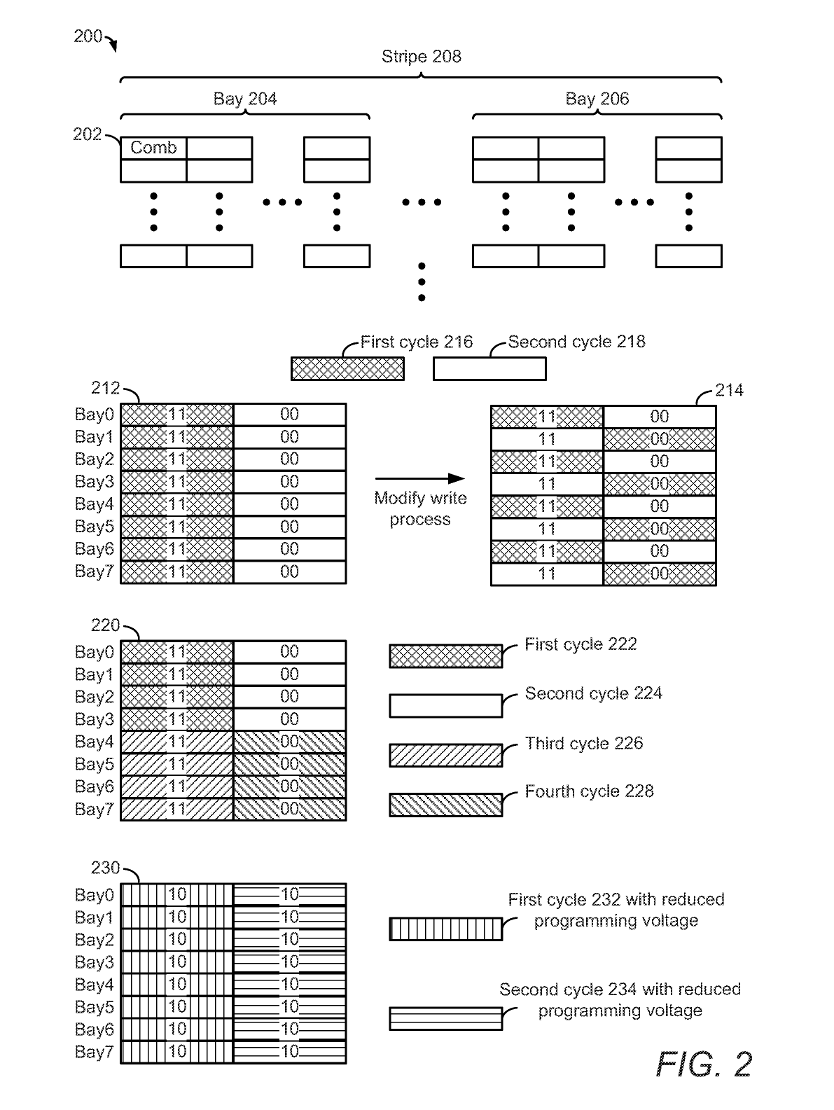

During operation, the controller 130 may receive data 150 and a request for write access to the memory 104 from the host device 154 via the host interface 148. The data 150 (or a representation of the data 150, such as an encoded and/or scrambled representation of the data 150) may be written to the memory 104 using a write process that includes multiple write operations. For example, to increase data throughput at the data storage device 102, the memory 104 may have an architecture that enables concurrent writing and reading of values of the data 150. The architecture may include combs, bays, and stripes, as described further with reference to FIG. 2.

The power mode circuitry 132 may be configured to determine an indication 134 of a power characteristic associated with the write process. The indication 134 may identify (or may correspond to) an estimated power consumption associated with a write process to write the data 150 to the memory 104, such as an estimated peak power usage that may occur during the write process. As used herein, a “peak power consumption” associated with a write process may refer to an amount of power consumed at a particular time during the write process, such as the largest “instantaneous” power consumption during the write process (as compared to an average power consumption occurring throughout the write process).

In an illustrative implementation, the power mode circuitry 132 is configured to determine a number of low-resistance programming operations (e.g., a number of storage elements of the memory 104 to be changed from a high-resistance state to a low-resistance state) associated with the write process, a number of cycles associated with the write process, another metric, or a combination thereof. In this example, the indication 134 may identify (or may be based on) the number of low-resistance programming operations). Alternatively or in addition, the power mode circuitry 132 may be configured to parse the data 150 (or a representation of the data 150, such as scrambled and/or encoded data that is based on the data 150) to detect one or more “harmful” patterns, such as bit patterns associated with high peak power consumption. An example of such a pattern may include data to be written that involves a large number of state changes in storage elements (e.g., a large number of set operations, a large number of reset operations, or a large number of set and reset operations). In this example, the indication 134 may identify a number of “harmful” patterns associated with the data 150 and/or a degree of “harmfulness” of each of the patterns associated with the data 150.

The controller 130 may be configured to provide the indication 134 to the comparator 136. The comparator 136 may be configured to determine whether the indication 134 satisfies (e.g., is greater than, or is greater than or equal to) a threshold 138 (e.g., by comparing the power characteristic to the threshold 138). The controller 130 may select a first write process (e.g., an unmodified write process, such as a “default” write process) or a second write process (e.g., a modified write process (i.e., a write process that is different than the “default” write process)) based on whether the indication 134 satisfies the threshold 138. For example, the controller 130 may initiate the first write process to write the data 150 to the memory 104 by issuing a write command 120 to the memory die 103, or the controller 130 may initiate the second write process to write the data 150 to the memory 104 by issuing a write command 122 to the memory die 103.

The write command 120 may be associated with a first power distribution mode (e.g., a default power distribution mode), and the write command 122 may be associated with a second power distribution mode (e.g., a peak power reducing mode). For example, the distribution circuitry 118 may be configured to detect a particular opcode included in the write command 122 and to initiate a modified write process at the memory 104 in response to detecting the particular opcode. The particular opcode may differ from an opcode of the write command 120 and may cause the distribution circuitry 118 to write the data 150 to the memory 104 using the modified write process to reduce power consumption and to avoid power consumption exceeding a peak power threshold as compared to performing an unmodified write process (e.g., a “default” write process).

To further illustrate, certain examples are described below. It should be appreciated that the examples are illustrative and that a power management scheme may depend on the particular application. Further, although the examples are described separately for convenience, it should be appreciated that two or more of the examples (or methods of the examples) can be combined, as described further below. Any of the examples may be triggered based on a power consumption characteristic associated with the data storage device 102, such as based on a determination by the controller 130 that the indication 134 satisfies the threshold 138, which may occur in response to a number of low-resistance programming operations associated with a write process, as an illustrative example.

In a first example, the controller 130 is configured to identify that writing the data 150 to the memory 104 involves programming at least a threshold number of storage elements of the memory 104 to a particular state during a particular programming cycle of the write process. For example, the particular state may correspond to a low-resistance state that is associated with higher power consumption than a high-resistance state. If the controller 130 determines that at least the threshold number of storage elements are to be programmed to the particular state (e.g., changed from a high-resistance state to a low-resistance state), the data storage device 102 may modify the write process by rescheduling one or more programming operations of the write process (e.g., one or more programming operations that are associated with the particular state). For example, the controller 130 may send the write command 122 to the memory die 103, and the write command 122 may cause the distribution circuitry 118 to reschedule the one or more programming operations. Rescheduling the one or more programming operations may interchange (e.g., change an order of) one or more low-resistance programming operations with one or more high-resistance programming operations to reduce a number of simultaneous low-resistance programming operations during a particular programming cycle. Alternatively or in addition, rescheduling one or more programming operations may “break” a write process into multiple write processes (e.g., by “splitting” write operations of a write process into a first write process and a second write process).

In a second example, the write command 122 causes the memory die 103 to reduce a number of concurrent programming operations during one or more programming cycles of the write process. In this example, a parallelism factor associated with the write process may be reduced. For example, a “default” parallelism factor of the memory 104 may be a particular number, and a write process may write the particular number of bits to the memory 104 during each cycle of the write process. The write process may be modified by reducing the parallelism factor and by increasing the number of cycles.

In a third example, the write command 122 causes the memory die 103 to decrease a programming voltage and to increase a programming duration during one or more programming cycles of the write process. In this example, the data storage device 102 may modify the write process by decreasing the programming voltage (and by increasing the programming duration to “spread” out peak power consumption associated with the write process). To illustrate, the distribution circuitry 118 may include multiple charge pumps, such as a first charge pump configured to generate a first programming voltage and a second charge pump configured to generate a second programming voltage that is less than the first programming voltage. The distribution circuitry 118 may selectively activate (e.g., by activating a switch) the first charge pump in response to receiving the write command 120 or the second charge pump in response to receiving the write command 122. The read/write circuitry 116 may be responsive to the first programming voltage or the second programming voltage (e.g., based on whether the switch is activated by the distribution circuitry 118), and the read/write circuitry 116 may write the data 150 using either the first programming voltage or the second programming voltage. Alternatively or in addition, the data storage device 102 may reduce a programming voltage using another technique, such as by activating a resistive voltage divider that may be included in the distribution circuitry 118, as an illustrative example.

In a fourth example, modifying the write process includes time-shifting (e.g., staggering) programming operations of the write process by delaying initiation of one or more of programming operations of the write process. For example, delaying initiation of one or more programming operations may “distribute” power consumption associated with write process initiation to avoid total power consumption at any time period exceeding a peak power consumption threshold. In a particular embodiment, the data storage device 102 may include multiple memory dies, and one or more write processes at the multiple memory dies may be delayed to avoid concurrent initiation of multiple write processes. For example, the distribution circuitry 118 may issue one or more micro-commands to the read/write circuitry 116 to delay (or inhibit) performance of a write process at the memory 104 to avoid concurrent performance of the write process with another write process at another die (not shown in FIG. 1). To illustrate, in an illustrative embodiment, the distribution circuitry 118 may delay asserting an enable signal at the read/write circuitry 116 that causes the read/write circuitry 116 to initiate a write process.

In a fifth example, bits of the data 150 may be written based on a power consumption (e.g., leakage current) associated with destination portions of the memory 104. For example, if certain portions of the memory 104 targeted by the write process are associated with higher leakage currents, the modified write process may distribute (e.g., reorder) writing of low-resistance values and high-resistance values of the data 150, such as to reduce a number of concurrent low-resistance programming operations. Portions of the memory 104 associated with higher leakage currents may be programmed with a first set of values of the data 150 (e.g., values corresponding to high-resistance states), and portions of the memory 104 associated with lower leakage currents may be programmed with a second set of values of the data 150 (e.g., values corresponding to low-resistance states). In this example, “health” information (e.g., power consumption, such as leakage currents) of portions of the memory 104 may be monitored (e.g., tracked) by the distribution circuitry 118 during operation of the data storage device 102. The “health” information may be tracked for one or more particular portions of the memory 104 (e.g., on a per-bay or per-comb basis).

In a sixth example, power consumption of portions of the memory 104 is measured in connection with a pre-processing production operation. For example, after fabrication of the memory die 103, leakage currents of portions of the memory 104 may be measured (e.g., as a one-time operation, instead of monitoring health of the memory 104 during the lifetime of the data storage device 102 as in the fifth example). In this example, portions of the memory 104 (e.g., bays or combs) that are associated with higher leakage currents may be programmed with a first set of values of the data 150 (e.g., values corresponding to high-resistance states), and portions of the memory 104 associated with lower leakage currents may be programmed with a second set of values of the data 150 (e.g., values corresponding to low-resistance states). Thus, the distribution circuitry 118 may modify the write process by assigning one or more values of the data 150 to a particular portion of the memory 104, such as by identifying that the particular portion is associated with higher leakage current or a lower leakage current and by assigning high-resistance states or low-resistance states of the data 150 to the particular portion based on the leakage current.

Thus, the data 150 (or a representation of the data 150) may be written to the memory 104 using a first write process (e.g., an unmodified write process based on the first power distribution mode) or using a second write process (e.g., a modified write process based on the second power distribution mode). Writing the data 150 (or a representation of the data 150) may result in information 108 being stored to the memory 104 (e.g., a set of resistive states programmed to the memory 104, such as high-resistance states and low-resistance states).

In response to storing the information 108 to the memory 104, the controller 130 may update the table 140. For example, the table 140 may store an indication 142 (e.g., a first set of entries) indicating data (or addresses of data) written to the memory 104 using the first power distribution mode. As another example, the table 140 may store an indication 144 (e.g., a second set of indications) indicating data (or addresses of data) written to the memory 104 using the second power distribution mode. The controller 130 may update the table 140 to indicate whether the information 108 has been written to the memory 104 using the first power distribution mode or the second distribution mode (e.g., by selectively modifying either the indication 142 or the indication 144). As an illustrative example, the table 140 may correspond to a logical-to-physical address table in which each entry is associated with a status bit. In this example, the indication 142 may correspond to a first value of the status bit (e.g., a logic “0” value), and the indication 144 may correspond to a second value of the status bit (e.g., a logic “1” value).

In response to receiving a request for read access to the information 108 from the host device 154, the controller 130 may access the table 140 to determine a read technique for accessing the information 108 from the memory 104. For example, if the table 140 indicates that the information 108 was written to the memory 104 using the first power distribution mode (e.g., in response to using the write command 120), the controller 130 may issue a read command 124 to the memory die 103 to initiate a read process to read the information 108. If the table 140 indicates that the information 108 was written to the memory 104 using the second power distribution mode (e.g., in response to using the write command 122), the controller 130 may issue a read command 126 to the memory die 103 to initiate the read process. The read command 126 may “undo” certain operations associated with the second power distribution mode (e.g., by reordering values if the values were rearranged in connection with a modified write process to reduce power consumption). In other implementations, a single read command may be used to read data written using the first power distribution mode and for data written using the second power distribution mode.

The example of FIG. 1 illustrates that peak power consumption can be managed at the data storage device 102. For example, using the example techniques of FIG. 1, certain write operations of “harmful” patterns (e.g., patterns to be written using a large number of set or reset operations, such as a large number of operations that program low-resistance states) can be modified to “distribute” power consumption (e.g., to avoid total power exceeding a peak power threshold, which may reduce physical stress at components of the data storage device 102.

Although certain aspects of FIG. 1 are described separately for convenience, it should be appreciated that certain examples can be combined by one of skill in the art based on the particular application. For example, although certain example techniques for modifying a write process have been described separately for convenience, it is noted that two or more write process modification techniques may be combined to further reduce peak power consumption. To further illustrate, the comparator 136 may be configured to utilize two or more thresholds. For example, the comparator 136 may be configured to determine whether the power characteristic associated with the indication 134 satisfies a second threshold that is greater than the threshold 138. In this example, if the power characteristic satisfies the second threshold, the controller 130 may initiate a third power distribution mode. The third power distribution mode may utilize one or more techniques described with reference to the first example, the second example, the third example, the fourth example, the fifth example, and the sixth example of FIG. 1. In this case, the controller 130 may issue a third write command to the memory die 103 to write the data 150 to the memory 104 based on the third power distribution mode. Alternatively or in addition, if the data storage device 102 is operating according to a low-power mode, the controller 130 may initiate a modified write process using the third power distribution mode.

FIG. 2 depicts an illustrative example of a memory architecture 200 of the memory 104 of FIG. 1. The memory architecture 200 includes multiple combs, such as a representative comb 202. Each comb of the memory architecture 200 may include multiple storage elements. Each of the multiple storage elements may be associated with a resistive state (e.g., a high-resistive state or a low resistive state) that indicates a logic value (e.g., a logic “0” value or a logic “1” value). As a non-limiting, illustrative example, each comb of the memory architecture may include a group of storage elements each associated with a resistive state, each of which may be programmed to the comb 202 in parallel.

In the memory architecture 200, multiple combs may be organized into a bay. For example, the memory architecture 200 includes a representative bay 204 that includes multiple combs, such as the comb 202. As another example, the memory architecture 200 further includes a bay 206. The bay 206 includes multiple combs.

FIG. 2 further illustrates that the memory architecture 200 may include one or more stripes. The one or more stripes may include a representative stripe 208. Each stripe of the memory architecture 200 may include multiple bays. For example, the stripe 208 may include multiple bays, such as the bays 204, 206. Although FIG. 2 illustrates one stripe (the stripe 208), it should be appreciated that the memory architecture 200 may include multiple stripes.

During a write process to write data to the memory 104 of FIG. 1, multiple bays of the memory 104 may be programmed in parallel. For example, the bays 204, 206 may be programmed in parallel, which may include writing multiple data values to multiple combs of each of the bays 204, 206 in parallel during a particular cycle of the write process. In a particular embodiment, the write process writes a single page of data to the memory 104 using a particular number of cycles.

To further illustrate, FIG. 2 depicts a write process 212 and a modified write process 214. In the write process 212, a first set of values is scheduled to be programmed in parallel during a first cycle 216 (i.e., a first set of logic “1” values), and a set of values is scheduled to be programmed in parallel during a second cycle 218 (i.e., a second set of logic “0” values). In this case, the write process 212 may be used to write a page having a bit sequence “11111111111111110000000000000000” to the memory 104 of FIG. 1. The page can be written to multiple bays (e.g., bays 0, 1, . . . 7), such as by writing a subset of the bits to each of the bays. In this example, a parallelism factor may be equal to the number of bays that are programmed per cycle. Although FIG. 2 depicts a particular number of bays for illustration, it should be appreciated that examples herein may be applicable to any number of bays. Further, although certain pages are described herein as having a certain number of bits for illustration, it should be appreciated that one or more pages may include another number of bits.

Programming the first set of data or the second set of data may be associated with a high power consumption. For example, if a logic “0” value corresponds to a low-resistance state, and if a default state (e.g., erase state) of storage elements is a high-resistance state, then programming the first set of values during the first cycle 216 may consume a large amount of power usage (and the second cycle 218 may incur little or no power usage). In this example, programming the first set of values during the first cycle 216 may cause power consumption to exceed a peak power consumption threshold.

The write process 212 may be modified to instead use the modified write process 214. Modifying the write process 212 may be performed in accordance with the first example described with reference to FIG. 1. For example, the distribution circuitry 118 of FIG. 1 may be configured to modify the write process 212, such as by rescheduling one or more programming operations of the write process 212. In this case, the distribution circuitry 118 may be configured to initiate or execute the modified write process 214 to write the data 150 to the memory 104 in response to receiving the write command 122.

In the modified write process 214, operations have been rescheduled so that some values of the first set of data are programmed during the first cycle 216 and so that some values of the second set of data are programmed during the second cycle 218. Accordingly, the modified write process 214 may be associated with a lower power consumption than the write process 212 (because the number of low-resistance programming operations in each cycle has been reduced in the modified write process 214). In this example, programming values of the first set of data during the first cycle 216 and programming values of the second set of data during the second cycle 218 may lower power consumption such that a total power consumption is less than a peak power consumption threshold.

FIG. 2 further illustrates a modified write process 220 that may be used to write a page to the memory 104 of FIG. 1, such as a page having a bit sequence “11111111111111110000000000000000” to the memory 104. In FIG. 2, the modified write process 220 may be performed using cycles 222, 224, 226, and 228, such as by “splitting” the first cycle 216 into the cycles 222, 226 and by “splitting” the second cycle 218 into cycles 224, 228 (e.g., by reducing a parallelism factor). As a result, fewer low-resistance states may be programmed concurrently (during a cycle) by the modified write process 220 as compared to the write process 212 (e.g., fewer low-resistance states per cycle). In a particular embodiment, the modified write process 220 corresponds to the second example described with reference to FIG. 1. In this case, the distribution circuitry 118 may be configured to initiate and/or execute the modified write process 220 to write the data 150 to the memory 104 in response to receiving the write command 122.

FIG. 2 further illustrates a modified write process 230 that may be used to write another page to the memory 104 of FIG. 1, such as a page having a bit sequence “10101010101010101010101010101010” to the memory 104. In FIG. 2, the modified write process 230 includes programming a first half of the page during a first cycle 232 using a reduced programming voltage and programs a second half of the page during a second cycle 234 using the reduced programming voltage. In a particular embodiment, the modified write process 230 corresponds to the third example described with reference to FIG. 1. In this case, the distribution circuitry 118 may be configured to initiate and/or execute the modified write process 230 to write the data 150 to the memory 104 in response to receiving the write command 122.

It is noted that other examples described with reference to FIG. 1 may be applicable to the memory architecture 200 of FIG. 2. For example, write operations can be delayed or staggered on a per-stripe, per-bay, or per-comb basis, such as using the fourth example. As another example, health information may be tracked during device operation on a per-stripe, per-bay, or per-comb basis, such as in accordance with the fifth example. As another example, health information may be determined during a pre-processing operation (e.g., after fabrication of the memory die 103), which may be performed on a per-stripe, per-bay, or per-comb basis, such as using the sixth example.

The examples of FIG. 2 illustrate that a memory may have a parallel architecture in which multiple data values are written to storage elements concurrently. Because a parallel architecture may be associated with a large peak power consumption in some cases, a write process may be modified to “distribute” power consumption throughput the write process, which may reduce stress applied to device components during the write process. For example, power consumption associated with the write process may be reduced such that the power consumption does not exceed a peak power consumption threshold.

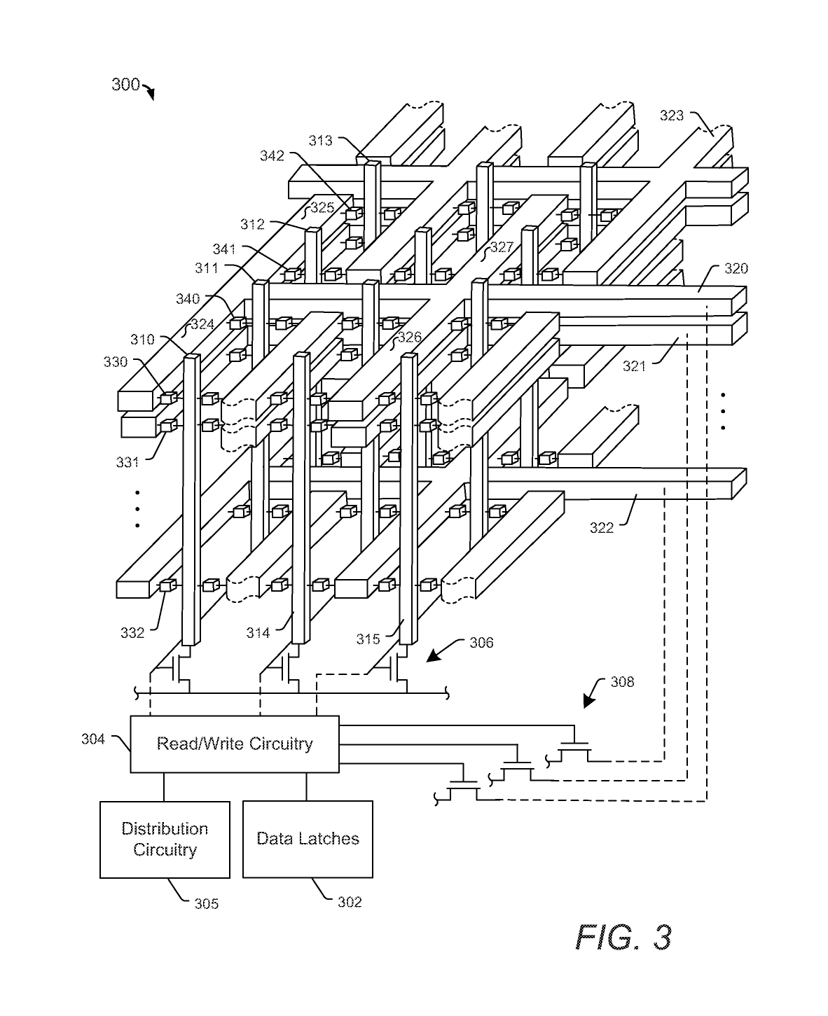

FIG. 3 is a diagram that illustrates a portion of a particular embodiment of a memory die 300 in a ReRAM configuration. The memory die 300 may be included in the data storage device 102 of FIG. 1. For example, the memory die 300 may correspond to the memory die 103 of FIG. 1. The memory die 300 may be coupled to the controller 130 of FIG. 1.

The memory die 300 may include data latches 302, read/write circuitry 304, and distribution circuitry 305. The data latches 302 may correspond to the data latches 114 of FIG. 1, the read/write circuitry 304 may correspond to the read/write circuitry 116 of FIG. 1, and the distribution circuitry 305 may correspond to the distribution circuitry 118 of FIG. 1. The read/write circuitry 304 is coupled to bit line drivers 306 and to word line drivers 308.

In the embodiment illustrated in FIG. 3, the memory die 300 includes a vertical bit line ReRAM with a plurality of conductive lines in physical layers over a substrate (e.g., substantially parallel to a surface of the substrate), such as representative word lines 320, 321, 322, and 323 (only a portion of which is shown in FIG. 3) and a plurality of vertical conductive lines through the physical layers, such as representative bit lines 310, 311, 312, and 313. The word line 322 may include or correspond to a first group of physical layers, and the word lines 320, 321 may include or correspond to a second group of physical layers.

The memory die 300 also includes a plurality of resistance-based storage elements (e.g., memory cells), such as representative storage elements 330, 331, 332, 340, 341, and 342. Each of the storage elements 330, 331, 332, 340, 341, and 342 is coupled to (or is associated with) a bit line and a word line in arrays of memory cells in multiple physical layers over the substrate (e.g., a silicon substrate).

In the embodiment illustrated in FIG. 3, each of the word lines includes a plurality of fingers. To illustrate, the word line 320 includes fingers 324, 325, 326, and 327. Each finger may be coupled to more than one bit line. For example, the finger 324 of the word line 320 is coupled to the bit line 310 via the storage element 330 at a first end of the finger 324 and the finger 324 is further coupled to the bit line 311 via the storage element 340 at a second end of the finger 324.

In the example of FIG. 3, each bit line may be coupled to more than one word line. To illustrate, the bit line 310 is coupled to the word line 320 via the storage element 330 and the bit line 310 is further coupled to the word line 322 via the storage element 332.

During a write operation, the controller 130 of FIG. 1 may receive data from a host device, such as the host device 154 of FIG. 1. The controller 130 may send the data (or a representation of the data) to the memory die 300. For example, the controller 130 may encode the data prior to sending the encoded data to the memory die 300. The data (or the representation of the data) may be latched into the data latches 302. The data may correspond to the data 150 of FIG. 1. The data may be sent using the write command 120 or the write command 122.

The distribution circuitry 305 may be responsive to an opcode of the write command 120 or the write command 122 to determine whether to program the data based on the first power distribution mode (e.g., using an unmodified or “default” write process) or based on the second power distribution mode (e.g., using a modified write process). For example, a first opcode of the write command 120 may cause the distribution circuitry 305 to select the first power distribution mode, and a second opcode of the write command 122 may cause the distribution circuitry 305 to select the second power distribution mode. Depending on the particular implementation, the second opcode may cause the distribution circuitry 305 to initiate and/or execute a modified write process that is in accordance with any of the first example, the second example, the third example, the fourth example, the fifth example, the sixth example described with reference to FIG. 1. It is further noted that a combination of the examples may be utilized. For example, another write command may be utilized that has another opcode that indicates that a write process is to use a combination of the examples.

The read/write circuitry 304 may write the data to storage elements corresponding to the destination of the data. For example, the read/write circuitry 304 may apply selection signals to selection control lines coupled to the word line drivers 308 and the bit line drivers 306 to cause a write voltage to be applied across a selected storage element. As an illustrative example, to select the storage element 330, the read/write circuitry 304 may activate the word line drivers 308 and the bit line drivers 306 to drive a programming current (also referred to as a write current) through the storage element 330. To illustrate, a first write current may be used to write a first logical value (e.g., a value corresponding to a high-resistance state) to the storage element 330, and a second write current may be used to write a second logical value (e.g., a value corresponding to a low-resistance state) to the storage element 330. The programming current may be applied by generating a programming voltage across the storage element 330 by applying a first voltage to the bit line 310 and to word lines other than the word line 320 and by applying a second voltage to the word line 320. In a particular embodiment, the first voltage is applied to other bit lines (e.g., the bit lines 314, 315) to reduce leakage current in the memory die 300.

During a read operation, the controller 130 may receive a request from a host device, such as the host device 154 of FIG. 1. The controller 130 may issue a command to the memory die 300, such as one of the read commands 124, 126.

The distribution circuitry 305 may be responsive to an opcode of the read command 124 or the read command 126 to determine whether to read the data based on the first power distribution mode (e.g., using an unmodified or “default” read process) or based on the second power distribution mode (e.g., using a modified read process). For example, a first opcode of the read command 124 may cause the distribution circuitry 305 to select the first power distribution mode, and a second opcode of the read command 126 may cause the distribution circuitry 305 to select the second power distribution mode. In another implementation, a single read command is used for both the first power distribution mode and the second power distribution mode.

The memory die 300 may cause the read/write circuitry 304 to read bits from particular storage elements of the memory die 300, such as by applying selection signals to selection control lines coupled to the word line drivers 308 and the bit line drivers 306 to cause a read voltage to be applied across a selected storage element. For example, to select the storage element 330, the read/write circuitry 304 may activate the word line drivers 308 and the bit line drivers 306 to apply a first voltage (e.g., 0.7 volts (V)) to the bit line 310 and to word lines other than the word line 320. A lower voltage (e.g., 0 V) may be applied to the word line 320. Thus, a read voltage is applied across the storage element 330, and a read current corresponding to the read voltage may be detected at a sense amplifier of the read/write circuitry 304. The read current corresponds (via Ohm's law) to a resistance state of the storage element 330, which corresponds to a logical value stored at the storage element 330. The logical value read from the storage element 330 and other elements read during the read operation may be provided to the controller 130 of FIG. 1 (e.g., via the data latches 302).

In a particular embodiment, the memory die 300 has a memory architecture corresponding to the memory architecture 200 of FIG. 2. To illustrate, write processes and read processes at the memory die 300 may be organized based on combs, stripes, and bays, as described with reference to FIG. 2. As a particular illustrative example, storage elements of the memory die 300 may be organized into a comb (e.g., the comb 202). The comb may be included in a bay (e.g., the bay 204), and the bay may be included in a stripe (e.g., the stripe 208).

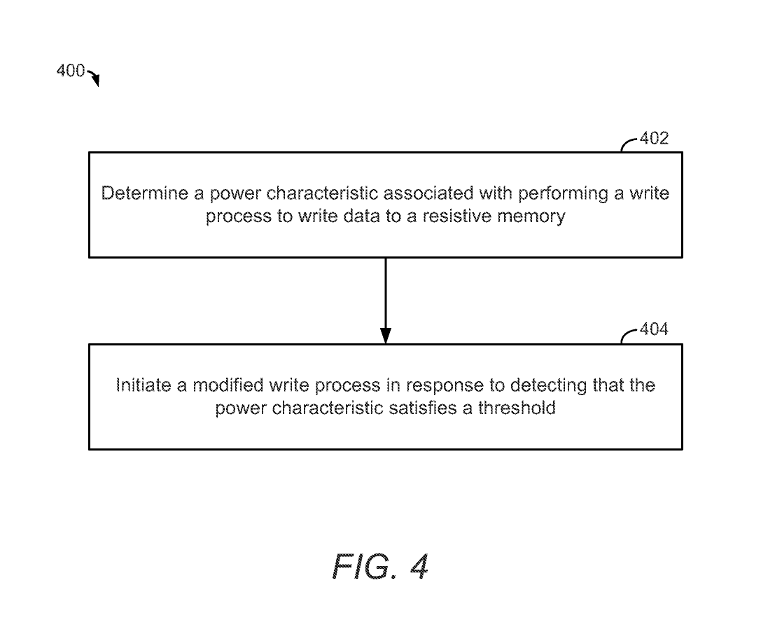

Referring to FIG. 4, an illustrative example of a method is depicted and generally designated 400. The method 400 may be performed at a data storage device (e.g., the data storage device 102) that includes a memory die (e.g., the memory die 103). As an example, the memory die may include a resistive memory, such as a resistive random access memory (ReRAM), which may correspond to the memory 104.

The method 400 may include determining a power characteristic associated with performing a write process to write data to the resistive memory, at 402. For example, the power characteristic may be determined by the power mode circuitry 132 of FIG. 1, and the power characteristic may be indicated by the indication 134. The data may correspond to the data 150.

The method 400 may further include selectively initiating a modified write process in response to detecting that the power characteristic satisfies a threshold, at 402. To illustrate, the comparator 136 may compare the indication 134 to the threshold 138 to determine whether the power characteristic satisfies the threshold 138. If the power characteristic satisfies the threshold 138, the controller 130 may initiate a modified write process by issuing the write command 122 to the memory die 103. In this case, operation may correspond to any of the first example, the second example, the third example, the fourth example, the fifth example, and/or the sixth example. If the power characteristic fails to satisfy the threshold 138, the controller 130 may initiate an unmodified write process by issuing the write command 120 to the memory die 103.

The method 400 of FIG. 4 illustrates that a write process may be selectively modified to reduce peak power consumption associated with the write process. Reducing peak power consumption may cause less physical stress to device components, which may improve operation and which may avoid physical damage to a device.

Although certain aspects are described herein separately for convenience, it should be appreciated that certain examples can be combined by one of skill in the art based on the particular application. For example, although certain example techniques for modifying a write process have been described separately for convenience, it is noted that two or more write process modification techniques may be combined to further reduce peak power consumption. To further illustrate, the comparator 136 may be configured to utilize two or more thresholds. For example, the comparator 136 may be configured to determine whether the power characteristic associated with the indication 134 satisfies a second threshold that is greater than the threshold 138. In this example, if the power characteristic satisfies the second threshold, the controller 130 may initiate a third power distribution mode. The third power distribution mode may utilize one or more techniques described with reference to the first example, the second example, the third example, the fourth example, the fifth example, and the sixth example of FIG. 1. In this case, the controller 130 may issue a third write command to the memory die 103 to write the data 150 to the memory 104 based on the third power distribution mode. Alternatively or in addition, if the data storage device 102 is operating according to a low-power mode, the controller 130 may initiate modified write processes using the third power distribution mode.

It is also noted that certain characteristics of the data storage device 102 may be modified (e.g., updated) using a firmware update or other update. To illustrate, as the data storage device 102 is operated, physical characteristics of the data storage device 102 may change (e.g., storage elements of the memory 104 may undergo physical degradation or wear). Change in physical characteristics may result in different power consumption characteristics, such as increased leakage current. In this case, the threshold 138 may be modified (e.g., via a firmware update), such as to reduce the threshold 138 in order to compensate for increased current consumption due to the physical wear, which could otherwise increase peak power usage at the data storage device.

Although the controller 130 and certain other components described herein are illustrated as block components and described in general terms, such components may include one or more microprocessors, state machines, and/or other circuits configured to enable the data storage device 102 (or one or more components thereof) to perform operations described herein. Components described herein may be operationally coupled to one another using one or more nodes, one or more buses (e.g., data buses and/or control buses), one or more other structures, or a combination thereof. One or more components described herein (e.g., the power mode circuitry 132, the comparator 136, and/or the distribution circuitry 118) may include one or more physical components, such as hardware controllers, state machines, logic circuits, one or more other structures, or a combination thereof, to enable the data storage device 102 to perform one or more operations described herein.

Alternatively or in addition, one or more aspects of the data storage device 102 may be implemented using a microprocessor or microcontroller programmed (e.g., by executing instructions) to perform operations described herein, such as one or more operations of the method 400 of FIG. 4. One or more operations described with reference to the power mode circuitry 132 and/or the comparator 136 may be implemented using a processor that executes instructions. In a particular embodiment, the data storage device 102 includes a processor executing instructions (e.g., firmware) retrieved from the memory 104. Alternatively or in addition, instructions that are executed by the processor may be retrieved from a separate memory location that is not part of the memory 104, such as at a read-only memory (ROM).

It should be appreciated that one or more operations described herein as being performed by the controller 130 may be performed at the memory 104. As an illustrative example, “in-memory” ECC operations may be performed at the memory die 103 alternatively or in addition to performing such operations at the controller 130. Further, certain operations described as being performed at the memory die 103 can be performed by the controller 130. For example, in certain applications, the distribution circuitry 118 of FIG. 1 may be included in the controller 130.

The data storage device 102 may be attached to or embedded within one or more host devices, such as within a housing of a host communication device (e.g., the host device 154). For example, the data storage device 102 may be integrated within an apparatus such as a mobile telephone, a computer (e.g., a laptop, a tablet, or a notebook computer), a music player, a video player, a gaming device or console, an electronic book reader, a personal digital assistant (PDA), a portable navigation device, or other device that uses internal non-volatile memory. However, in other embodiments, the data storage device 102 may be implemented in a portable device configured to be selectively coupled to one or more external devices, such as the host device 154.

To further illustrate, the data storage device 102 may be configured to be coupled to the host device 154 as embedded memory, such as in connection with an embedded MultiMedia Card (eMMC®) (trademark of JEDEC Solid State Technology Association, Arlington, Va.) configuration, as an illustrative example. The data storage device 102 may correspond to an eMMC device. As another example, the data storage device 102 may correspond to a memory card, such as a Secure Digital (SD®) card, a microSD® card, a miniSD™ card (trademarks of SD-3C LLC, Wilmington, Del.), a MultiMediaCard™ (MMC™) card (trademark of JEDEC Solid State Technology Association, Arlington, Va.), or a CompactFlash® (CF) card (trademark of SanDisk Corporation, Milpitas, Calif.). The data storage device 102 may operate in compliance with a JEDEC industry specification. For example, the data storage device 102 may operate in compliance with a JEDEC eMMC specification, a JEDEC Universal Flash Storage (UFS) specification, one or more other specifications, or a combination thereof.

Semiconductor memory devices include volatile memory devices, such as dynamic random access memory (“DRAM”) or static random access memory (“SRAM”) devices, non-volatile memory devices, such as resistive random access memory (“ReRAM”), electrically erasable programmable read only memory (“EEPROM”), flash memory (which can also be considered a subset of EEPROM), ferroelectric random access memory (“FRAM”), and other semiconductor elements capable of storing information. Each type of memory device may have different configurations. For example, flash memory devices may be configured in a NAND or a NOR configuration.

The memory devices can be formed from passive and/or active elements, in any combinations. By way of non-limiting example, passive semiconductor memory elements include ReRAM device elements, which in some embodiments include a resistivity switching storage element, such as an anti-fuse, phase change material, etc., and optionally a steering element, such as a diode, etc. Further by way of non-limiting example, active semiconductor memory elements include EEPROM and flash memory device elements, which in some embodiments include elements containing a charge storage region, such as a floating gate, conductive nanoparticles, or a charge storage dielectric material.

Multiple memory elements may be configured so that they are connected in series or so that each element is individually accessible. By way of non-limiting example, flash memory devices in a NAND configuration (NAND memory) typically contain memory elements connected in series. A NAND memory array may be configured so that the array is composed of multiple strings of memory in which a string is composed of multiple memory elements sharing a single bit line and accessed as a group. Alternatively, memory elements may be configured so that each element is individually accessible, e.g., a NOR memory array. NAND and NOR memory configurations are exemplary, and memory elements may be otherwise configured.

The semiconductor memory elements located within and/or over a substrate may be arranged in two or three dimensions, such as a two dimensional memory structure or a three dimensional memory structure. In a two dimensional memory structure, the semiconductor memory elements are arranged in a single plane or a single memory device level. Typically, in a two dimensional memory structure, memory elements are arranged in a plane (e.g., in an x-z direction plane) which extends substantially parallel to a major surface of a substrate that supports the memory elements. The substrate may be a wafer over or in which the layer of the memory elements are formed or it may be a carrier substrate which is attached to the memory elements after they are formed. As a non-limiting example, the substrate may include a semiconductor such as silicon.

The memory elements may be arranged in the single memory device level in an ordered array, such as in a plurality of rows and/or columns. However, the memory elements may be arrayed in non-regular or non-orthogonal configurations. The memory elements may each have two or more electrodes or contact lines, such as bit lines and word lines.

A three dimensional memory array is arranged so that memory elements occupy multiple planes or multiple memory device levels, thereby forming a structure in three dimensions (i.e., in the x, y and z directions, where the y direction is substantially perpendicular and the x and z directions are substantially parallel to the major surface of the substrate). As a non-limiting example, a three dimensional memory structure may be vertically arranged as a stack of multiple two dimensional memory device levels. As another non-limiting example, a three dimensional memory array may be arranged as multiple vertical columns (e.g., columns extending substantially perpendicular to the major surface of the substrate, i.e., in the y direction) with each column having multiple memory elements in each column. The columns may be arranged in a two dimensional configuration, e.g., in an x-z plane, resulting in a three dimensional arrangement of memory elements with elements on multiple vertically stacked memory planes. Other configurations of memory elements in three dimensions can also constitute a three dimensional memory array.

By way of non-limiting example, in a three dimensional NAND memory array, the memory elements may be coupled together to form a NAND string within a single horizontal (e.g., x-z) memory device levels. Alternatively, the memory elements may be coupled together to form a vertical NAND string that traverses across multiple horizontal memory device levels. Other three dimensional configurations can be envisioned wherein some NAND strings contain memory elements in a single memory level while other strings contain memory elements which span through multiple memory levels. Three dimensional memory arrays may also be designed in a NOR configuration and in a ReRAM configuration.

Typically, in a monolithic three dimensional memory array, one or more memory device levels are formed above a single substrate. Optionally, the monolithic three dimensional memory array may also have one or more memory layers at least partially within the single substrate. As a non-limiting example, the substrate may include a semiconductor such as silicon. In a monolithic three dimensional array, the layers constituting each memory device level of the array are typically formed on the layers of the underlying memory device levels of the array. However, layers of adjacent memory device levels of a monolithic three dimensional memory array may be shared or have intervening layers between memory device levels.

Alternatively, two dimensional arrays may be formed separately and then packaged together to form a non-monolithic memory device having multiple layers of memory. For example, non-monolithic stacked memories can be constructed by forming memory levels on separate substrates and then stacking the memory levels atop each other. The substrates may be thinned or removed from the memory device levels before stacking, but as the memory device levels are initially formed over separate substrates, the resulting memory arrays are not monolithic three dimensional memory arrays. Further, multiple two dimensional memory arrays or three dimensional memory arrays (monolithic or non-monolithic) may be formed on separate chips and then packaged together to form a stacked-chip memory device.

Associated circuitry is typically required for operation of the memory elements and for communication with the memory elements. As non-limiting examples, memory devices may have circuitry used for controlling and driving memory elements to accomplish functions such as programming and reading. This associated circuitry may be on the same substrate as the memory elements and/or on a separate substrate. For example, a controller for memory read-write operations may be located on a separate controller chip and/or on the same substrate as the memory elements.

One of skill in the art will recognize that this invention is not limited to the two dimensional and three dimensional exemplary structures described but cover all relevant memory structures within the spirit and scope of the invention as described herein and as understood by one of skill in the art. The illustrations of the embodiments described herein are intended to provide a general understanding of the various embodiments. Other embodiments may be utilized and derived from the disclosure, such that structural and logical substitutions and changes may be made without departing from the scope of the disclosure. This disclosure is intended to cover any and all subsequent adaptations or variations of various embodiments. Those of skill in the art will recognize that such modifications are within the scope of the present disclosure.

The above-disclosed subject matter is to be considered illustrative, and not restrictive, and the appended claims are intended to cover all such modifications, enhancements, and other embodiments, that fall within the scope of the present disclosure. Thus, to the maximum extent allowed by law, the scope of the present invention is to be determined by the broadest permissible interpretation of the following claims and their equivalents, and shall not be restricted or limited by the foregoing detailed description.

What is claimed is:

1. A method comprising:
at a data storage device that includes a memory die, wherein the memory die includes a resistive memory, performing:
determining a power characteristic associated with performing a write process to write data to the resistive memory; and
initiating a modified write process in response to detecting that the power characteristic satisfies a threshold.

2. The method of claim 1, wherein performing the modified write process reduces a peak power consumption as compared to performing the write process.

3. The method of claim 1, further comprising:
determining that the write process is to program at least a threshold number of storage elements of the resistive memory to a particular state during a particular programming cycle of the write process; and
rescheduling one or more programming operations of the write process that are associated with the particular state.

4. The method of claim 3, wherein rescheduling the one or more programming operations of the write process interchanges one or more low-resistance programming operations with one or more high-resistance programming operations to reduce a number of low-resistance programming operations during the particular programming cycle.

5. The method of claim 1, wherein modifying the write process includes reducing a number of programming operations during one or more programming cycles of the write process.

6. The method of claim 1, wherein modifying the write process includes decreasing a programming voltage during one or more programming cycles of the write process.

7. The method of claim 1, wherein modifying the write process increases a programming duration during one or more programming cycles of the write process.

8. The method of claim 1, wherein modifying the write process includes time-shifting programming operations of the write process.

9. The method of claim 1, wherein portions of the resistive memory targeted by the write process are associated with leakage currents, and wherein the modified write process distributes data to the portions.

10. The method of claim 1, wherein portions of the resistive memory targeted by the write process are associated with leakage currents, and wherein the modified write process assigns one or more values to a particular portion based on a number of low-resistance states.

11. The method of claim 1, wherein the resistive memory has a three-dimensional (3D) memory configuration that is monolithically formed in one or more physical levels of arrays of memory cells having an active area above a silicon substrate, and wherein the memory die further includes circuitry associated with operation of the memory cells.

12. A data storage device comprising:
a memory die, wherein the memory die includes a resistive memory; and
a controller, wherein the controller is coupled to the memory die, wherein the controller is configured to initiate a write process to write data to the resistive memory using either a first write command that causes the memory die to perform the write process according to a first power distribution mode or using a second write command that causes the memory die to perform the write process according to a second power distribution mode.

13. The data storage device of claim 12, wherein the controller includes power mode circuitry configured to determine whether to initiate the first power distribution mode using the first write command or the second power distribution mode using the second write command.

14. The data storage device of claim 13, wherein the power mode circuitry is further configured to select the first power distribution mode or the second power distribution mode based on whether a power characteristic associated with the write process satisfies a threshold.

15. The data storage device of claim 13, wherein the power mode circuitry is further configured to determine the power characteristic based on a number of low-resistance programming operations associated with the write process, a number of cycles associated with the write process, another metric, or a combination thereof.

16. The data storage device of claim 12, wherein the memory die further includes distribution circuitry configured to perform a second write process in response to receiving the second command to reduce a peak power consumption associated with the write process.

17. The data storage device of claim 12, wherein the controller is further configured to store a table and to selectively update the table to indicate whether information written to the resistive memory by the write process is associated with the first power distribution mode or the second power distribution mode.

18. The data storage device of claim 12, wherein the resistive memory is a resistive random access memory (ReRAM).

19. The data storage device of claim 12, wherein the resistive memory has a three-dimensional (3D) memory configuration.

20. The data storage device of claim 19, wherein the 3D memory configuration is monolithically formed in one or more physical levels of arrays of memory cells having an active area above a silicon substrate, and wherein the memory die further includes circuitry associated with operation of the memory cells.
